(19) United States
(12) Patent Application Publication
(10) Pub. No.: US 2002/0181031 A1
(43) Pub. Date: Dec. 5, 2002

(54) Automatic document feeder for an image forming apparatus

(75) Inventors: Po-Hua Fang, Taipei (TW); Shu-Ya Chiang, Taichung (TW)

Correspondence Address: LOWE HAUPTMAN GILMAN, & BERNER, LLP, 1700 Diagonal Road, Suite 310, Alexandria, VA, 22314, US

(73) Assignee: UMAX DATA SYSTEMS INC.

(21) Appl. No.: 09/870,514

(22) Filed: Jun. 1, 2001

(51) Int. Cl. H04N 1/04

(52) U.S. Cl. 358/498

(57) ABSTRACT

An automatic document feeder for an image forming apparatus, such as a scanner, is provided. The automatic document feeder comprises a document-loading means, a document-receiving means, a sheet path, a sheet-transporting mechanism, a scan window, a first sensor means and a second sensor means. The first sensor means is disposed at the entrance of the sheet path and the second sensor means is disposed at a predetermined position along the sheet path. The second sensor means includes a sensor device and a rotatable shaft attached thereto. When the sheet-transporting mechanism transports at least one sheet along the sheet path through the second sensor means, the rotatable shaft is rotated at a predetermined angle.

### BACKGROUND OF THE INVENTION

1. Field of the Invention

The present invention relates to an automatic document feeder (ADF), and more particularly to an automatic document feeder used with an image forming apparatus.

2. Description of the Prior Art

An automatic document feeder (ADF) is extensively used with a copier or similar image forming apparatus, e.g. a scanner, for automatically and sequentially feeding a plurality of documents with images thereon to a scanning position. At the scanning position, the document is illuminated to reproduce an image thereof on a media, e.g. a sheet of paper or transparency.

FIG. 1 is a schematic side view of a prior automatic document feeder 10. In FIG. 1, the automatic document feeder 10 is mounted on an image processing apparatus, such as a flatbed scanner 12, and includes a document-feeding tray 101, a document-receiving tray 102, a feed-in roller 103, a first transport roller pair 104, a second transport roller pair 105, an exit roller pair 106, a first sensor means 107, a second sensor means 108 and a third sensor means 109, paper paths 110A, 110B and 110C, and a scan window 111. The flatbed scanner 12 has a scan head 121 disposed therein and under the scan window 111. The scan head 121 provides a light source and an image reading device, e.g. a charge coupled device (CCD) (not shown). The document-feeding tray 101 loads a stack of documents P1. The document-receiving tray 102 is placed under the document-feeding tray 101 for receiving and stacking documents one by one that are sequentially fed out from the document-feeding tray 101. The paper path 110C includes the scan window 111 that is provided such that the flatbed scanner 12 can read image information of the document being transported through the paper paths 110C through the scan window 111. The feed-in roller 103, the first transport roller pair 104, the second transport roller pair 105, and the exit roller pair 106 are arranged along a path including the paper paths 110A, 110B and 110C in which a document fed from the document-feeding tray 101 is conveyed to the document-receiving tray 102. The feed-in roller 103 pulls a sheet of a document out from the stack of the document P1 on the document-feeding tray 101 and feeds the sheet into the paper paths 110A. The first sensor means 107 disposed at the entrance of the paper path 110A detects feed-in of the sheet from the stack of the document P1. The first transport roller pair 104, the second transport roller pair 105, and the exit roller pair 106 transports the sheet through the paper paths 110B and 110C to the document-receiving tray 102. The second sensor means 108 is disposed at the paper path 110B and served to detect if the transportation of the sheet along the paper paths 110B is smooth. The third sensor means 109 is disposed at the paper path 110C close to the scanning position. When the sheet is transported through the third sensor means 109, the third sensor means 109 detects the sheet accessing to the scanning start position. The flatbed scanner 12 is then started.

In the prior automatic document feeder 10, it is necessary to use three sensor means to execute three different functions, i.e. feed-in of a sheet of a document to the paper path, transportation along the paper path and accessing to the scanning start position. The sensor means is very expensive, thus causing the high production cost of the automatic document feeder 10. Therefore, it is an intention to provide an improved automatic document feeder used with an image forming apparatus, which can save the number of the sensor means and reduce the production cost.

### SUMMARY OF THE INVENTION

It is one objective of the present invention to provide an automatic document feeder for an image forming apparatus, which utilizes the image sensor of the image forming apparatus instead of a sensor means to detect accessing of a sheet of a document to the scanning start position, so that the sensor means is saved and the production cost is reduced.

In order to achieve the above objective of this invention, the present invention provides an automatic document feeder used with an image forming apparatus. The automatic document feeder comprises a document-feeding means, a document-receiving means, a sheet path, a sheet-transporting mechanism, a first sensor means, a second sensor means and a scan window. The first sensor means is disposed at the entrance of the sheet path and the second sensor means is disposed at a predetermined position along the sheet path. The second sensor means includes a sensor device and a rotatable shaft attached thereto. When the sheet-transporting mechanism transports at least one sheet along the sheet path through the second sensor means, the rotatable shaft is rotated to block the light emitted from a light source of the image forming apparatus. The image sensor of the image forming apparatus will sense the reflective light from the rotatable shaft and detect the at least one sheet accessing to the scanning start position of the scan window. The image forming apparatus is then started.

### BRIEF DESCRIPTION OF THE DRAWINGS

The present invention can be best understood through the following description and accompanying drawings, wherein:

FIG. 1 shows a schematic side view of a prior automatic document feeder used with a flatbed scanner;

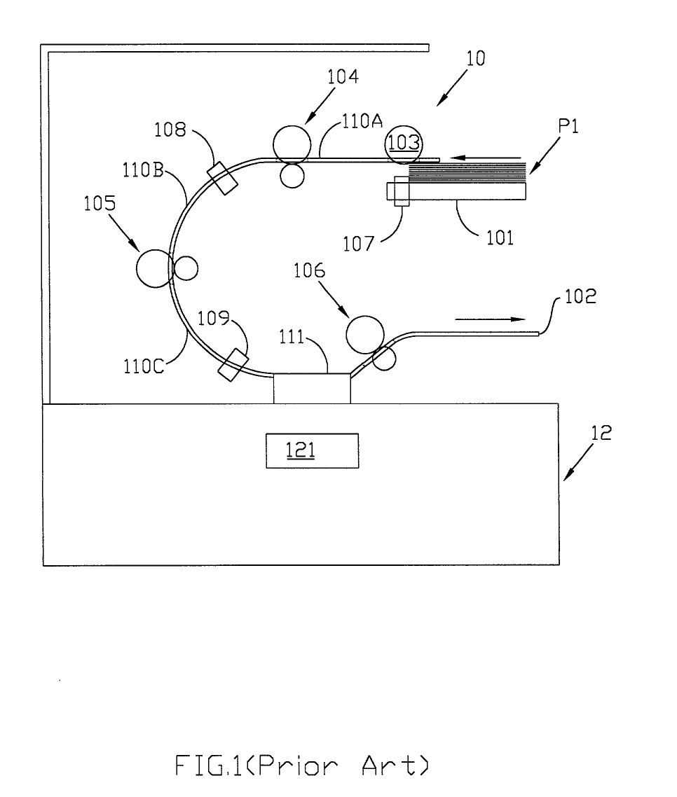

FIG. 2 shows a schematic side view of an automatic document feeder used with a flatbed scanner according to one preferred embodiment of the present invention;

FIG. 3A shows a schematic side view of the preferred embodiment of FIG. 2, wherein a sheet of a document is pulled to the sheet path by a feed-in roller;

FIG. 3B shows a schematic side view of the preferred embodiment of FIG. 2, wherein the sheet is transported along the sheet path through a second sensor means; and

FIG. 3C shows a schematic side view of the preferred embodiment of FIG. 2, wherein the sheet is fed out through an exit roller pair.

### DESCRIPTION OF THE PREFERRED EMBODIMENT

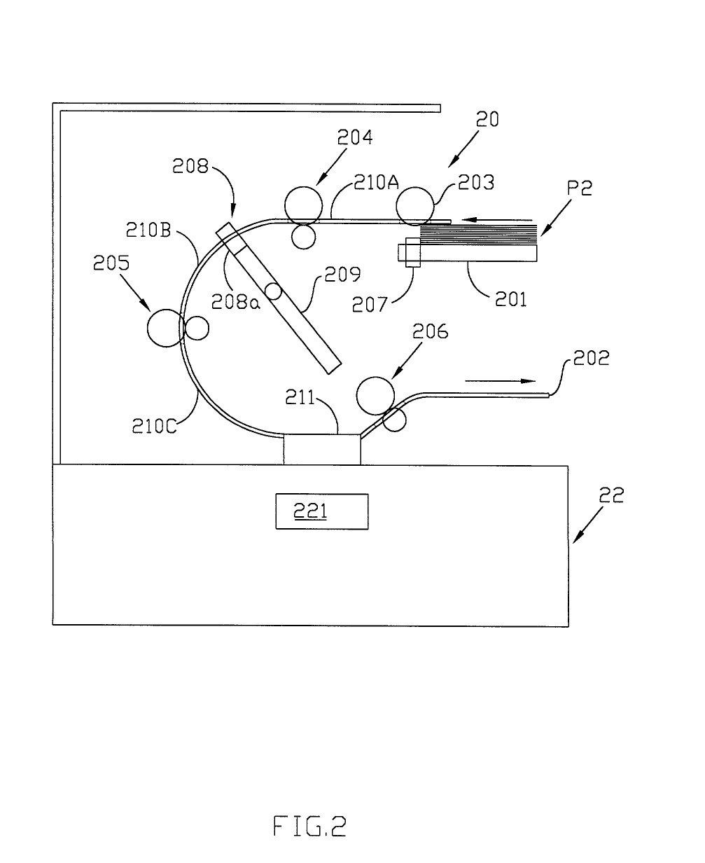

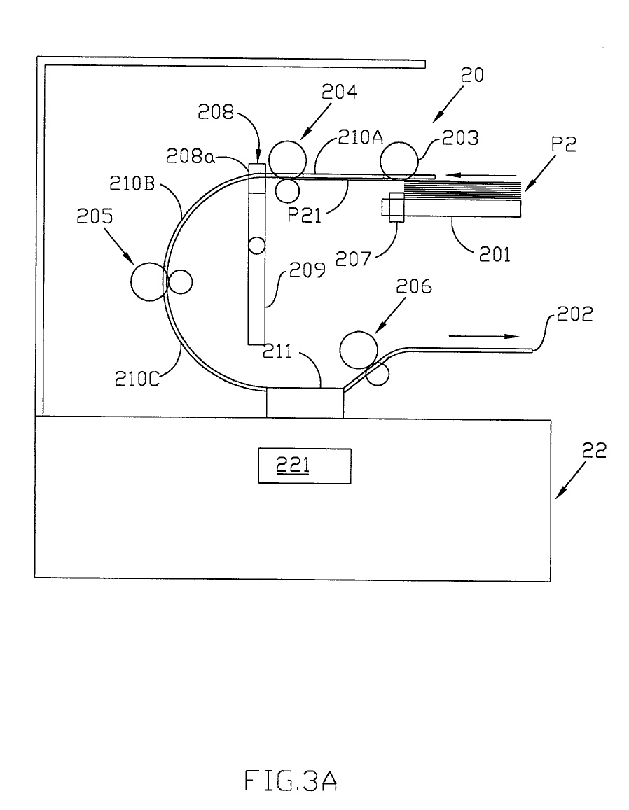

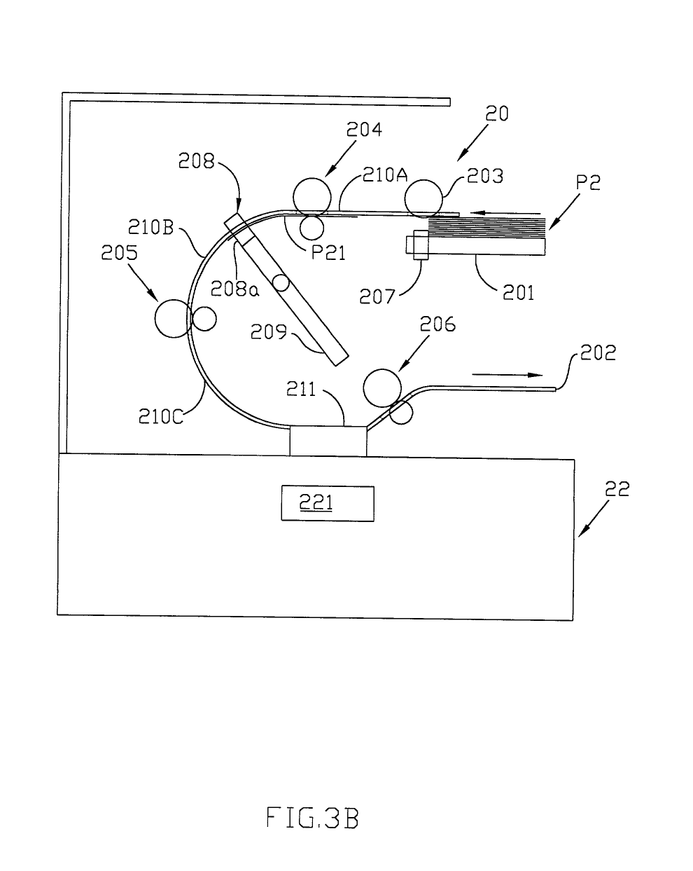

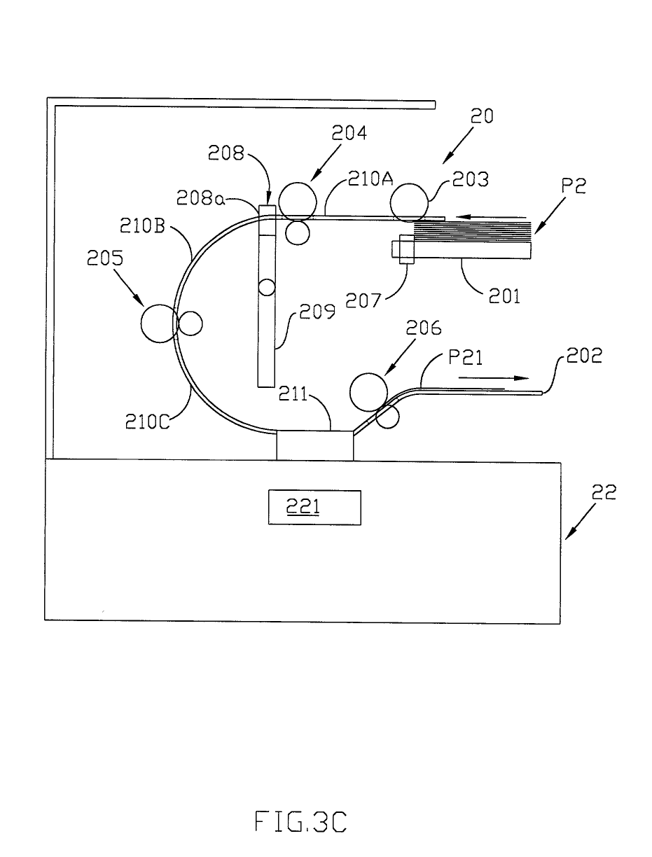

Referring now to the drawings and more particularly to FIG. 2 and FIG. 3A to FIG. 3C, there is shown an automatic document feeder which is constructed in accordance with the preferred embodiment of the present invention and which is adapted for use with a flatbed scanner.

Although in the preferred embodiment of the present invention, reference is made to a flatbed scanner, those skilled in the art will understand any type of flatbed input device can be utilized, such as a flatbed copier.

FIG. 2 is a schematic side view of an automatic document feeder 20 according to one preferred embodiment of the present invention. Referring to FIG. 2, the automatic document feeder 20 is mounted on an image scanner 22, e.g. a flatbed scanner. The automatic document feeder 20 includes a document-feeding means 201, a document-receiving means 202, a sheet-transporting mechanism including a feed-in roller 203, a first transport roller pair 204, a second transport roller pair 205 and an exit roller pair 206, a first sensor means 207, a second sensor means 208 including a sensor device 208a and a rotatable shaft 209 attached thereto, sheet paths 210A, 210B and 210C, and a scan window 211. The sheet paths 210A, 210B and 210C include at least a sheet-guiding plate.

The document-feeding means 201 loads a stack of documents P2. The document-receiving means 202 is placed under the document-feeding means 201 for receiving the documents one by one, which have been sequentially fed out from the document-feeding means 201. The first sensor means 207 is disposed at the entrance of the sheet path 210A. The second sensor means 208 is disposed at a predetermined position at the sheet path 210B. The sheet path 210C includes a scan window 211 that is provided such that the image scanner 22 reads information carried on the document, which is being transported through the scan window 211. The feed-in roller 203, the first transport roller pair 204, the second transport roller pair 205, and the exit roller pair 206 are arranged along the sheet paths 210A, 210B and 210C. The feed-in roller 203 pulls a sheet out from the stack of the documents P2 on the document-feeding means 201, and feeds the sheet to the first transport roller pair 204 through the sheet path 210A. The first transport roller pair 204, the second transport roller pair 205, and the exit roller pair 206 sequentially transports the sheet through the sheet paths 210B and 210C into the document-receiving means 202.

The image scanner 22 includes a scan head 221 with a line-image-sensor such as, for example, a charge-coupled-device (CCD), and a light source (both which are not shown). The scan head 221 is under the scan window 211. The line-image-sensor scans a widthwise line of the document to read the information carried on the line. The widthwise direction or scanning direction of the line-image-sensor is perpendicular to the surface of the sheet. The line-image-sensor reads information from the leading edge to the trailing edge of the document, line by line, while the document is being transported through the scan window 211.

Referring to FIG. 3A, when the feed-in roller 203 pulls a sheet P21 out from the stack of the documents P2 on the document-feeding means 201, and feeds the sheet P21 to the first transport roller pair 204 through the sheet path 210A, the first sensor means 207 will detect feed-in of the sheet P21 to the sheet path 210A. Referring to FIG. 3B, when the sheet P21 is transported along the sheet path 210B through the second sensor means 208, the sensor device 208a will detect the transportation of the sheet P21 along the sheet path 210B. At the same time, the rotatable shaft 209 is rotated counterclockwise to a predetermined angle to block the light emitted from the light source within the scan head 221. The line-image-sensor will sense the reflective light from the rotatable shaft 209 and detect the sheet P21 accessing to the scanning start position. The image scanner 22 is then started. Referring to FIG. 3C, when the trailing edge of the sheet P21 leaves the scan window 211, the exit transport roller pair 206 transports the sheet P21 into the document-receiving means 202.

By means of the improved structure of the automatic document feeder 20 of this invention, the sensor means used to detect if a sheet accesses to the scanning start position is saved and replaced by the line-image-sensor of the image scanner 12. Therefore, the present invention provides cost reduction.

The preferred embodiment is only used to illustrate the present invention; it is not intended to limit the scope thereof. Many modifications of the preferred embodiment can be made without departing from the spirit of the present invention.

What is claimed is:

1. An image scanner with an automatic document feeder for scanning a document, comprising:
a housing;
a scan head with a light source disposed within said housing;
a scan window disposed upon said housing and over said scan head;
a document-feeding means for loading at least one sheet thereupon;
a document-receiving means arranged below said document-feeding means for receiving and stacking the at least one sheet one by one transported from said document-feeding means;
a sheet path configured to guide the at least one sheet transported from said document-feeding means to said document-receiving means;
a sheet-transporting mechanism configured to transport the at least one sheet one by one along said sheet path from said document-feeding means to said document-receiving means;
a first sensor means disposed at the entrance of said sheet path to detect feed-in of the at least one sheet from said document-feeding means; and
a second sensor means disposed at a predetermined position along said sheet path, said second sensor means including a sensor device and a rotatable shaft attached to said sensor device;
wherein, said sheet-transporting mechanism transports the at least one sheet along said sheet path through said second sensor means, said rotatable shaft is counterclockwise rotated to block the light emitted from said light source.

2. The image scanner as claimed in claim 1, wherein said sheet path includes a U-turn sheet path.

3. The image scanner as claimed in claim 1, wherein said sheet path includes a plurality of sheet-guiding plates.

4. The image scanner as claimed in claim 2, wherein said sheet path includes a plurality of sheet-guiding plates.

5. The image scanner as claimed in claim 1, wherein said sheet-transporting mechanism includes a plurality of sheet-transporting rollers.

6. An automatic document feeder, comprising:
a document-feeding means for loading at least one sheet thereupon;
a document-receiving means arranged below said document-feeding means for receiving and stacking the at least one sheet one by one transported from said document-feeding means;
a sheet path configured to guide the at least one sheet transported from said document-feeding means to said document-receiving means;
a sheet-transporting mechanism configured to transport the at least one sheet one by one along said sheet path from said document-feeding means to said document-receiving means;
a scan window disposed at said sheet path close to said document-receiving means;
a first sensor means disposed at the entrance of said sheet path to detect feed-in of the at least one sheet from said document-feeding means; and
a second sensor means disposed at a predetermined position along said sheet path, said second sensor means including a sensor device and a rotatable shaft attached to said sensor device;
wherein, said sheet-transporting mechanism transports the at least one sheet along said sheet path through said second sensor means, said rotatable shaft is counterclockwise rotated a predetermined angle.

7. The automatic document feeder as claimed in claim 6, wherein said sheet path includes a U-turn sheet path.

8. The automatic document feeder as claimed in claim 6, wherein said sheet path includes a plurality of sheet-guiding plates.

9. The automatic document feeder as claimed in claim 7, wherein said sheet path includes a plurality of sheet-guiding plates.

10. The automatic document feeder as claimed in claim 6, wherein said sheet-transporting mechanism includes a plurality of sheet-transporting rollers.
